(19) United States
(12) Patent Application Publication
(10) Pub. No.: US 2026/0301036 A1
(43) Pub. Date: Oct. 1, 2026

(54) SYSTEM, APPARATUS AND METHOD FOR EVENT PUBLISHING AND ACCESS MANAGEMENT

(71) Applicant: W.W. GRAINGER, INC., Lake Forest, IL (US)

(72) Inventors: Pradeep NAGISETTY, Lake Forest, IL (US); Michael GORE, Ingleside, IL (US); Kannan PARAMASIVAM, Lake Forest, IL (US); José GONZALEZ, Lake Forest, IL (US); Rocío Elizabeth MERA SUÁREZ, Lake Forest, IL (US)

(21) Appl. No.: 19/578,469

(22) Filed: Mar. 25, 2026

Related U.S. Application Data
(60) Provisional application No. 63/777,439, filed on Mar. 25, 2025.

(51) Int. Cl. G06Q 30/0601

(52) U.S. Cl. CPC G06Q 30/0603

(57) ABSTRACT

A system, apparatus and computer-enabled method of managing an event data product catalog, comprising authenticating users through a developer platform interface or standalone service using [bearer tokens and group membership claims from an enterprise identity provider to determine access permissions; validating event topics against quality standards and required business metadata, including creation date, owning team, roster ID, and contact information; enriching validated topics with metadata about serialization format and data sensitivity through a data enrichment API; publishing validated and enriched topics as event data products by tagging them in the broker system, making them discoverable based on environment, domain, and ownership filters; managing access control through automated infrastructure-as-code generation, wherein access requests trigger creation of code snippets submitted as pull requests to event owners' provisioning repositories; and maintaining catalog consistency through automated workflows that integrate authentication, validation, and version control to ensure discoverable events remain production-ready and properly authorized.

### CROSS-REFERENCE TO RELATED APPLICATIONS

This application claims the benefit of and priority to U.S. Provisional Application No. 63/777,439 filed Mar. 25, 2025, the disclosure of which is incorporated by reference herein in its entirety.

### BACKGROUND

Enterprise organizations face ongoing challenges in managing and discovering real-time event streams across distributed systems using event-based computer architecture. Traditional data catalogs focus on static data assets, creating gaps when addressing real-time event management and discovery needs. While these catalogs handle databases, data warehouses, and file systems effectively, they have limitations when managing streaming data products and their associated metadata.

Current solutions often treat event stream access as a point-in-time configuration rather than as infrastructure-as-code. This makes it difficult to maintain audit trails and ensure consistent access patterns across environment changes, potentially causing disruptions during system updates or infrastructure migrations.

Security implementation in existing systems often relies on role-based access control at the broker level, with limited integration with enterprise authentication systems and restricted control over topic visibility and access rights. This creates challenges for organizations implementing governance while enabling self-service discovery and access to event streams.

Organizations have attempted to address these challenges through custom tooling, resulting in coupled implementations that require significant effort to maintain and adapt as technology stacks evolve. The connection between business logic and infrastructure concerns makes it difficult to modify or extend these systems as organizational needs change.

These constraints demonstrate the need for a solution that addresses the requirements of real-time event catalog management while maintaining security and governance standards. The present invention provides a solution through its approach to event product management and infrastructure-as-code integration.

### BRIEF SUMMARY

The solution presented describes an event system that makes real-time events discoverable and reusable across teams via an event catalog. The system's infrastructure-as-code approach ensures continuity of both events and cross-access permissions, distinguishing it from traditional static data catalogs. The event catalog solution variants represent an advancement in enterprise event stream management by transforming how organizations discover, share, and control access to real-time data products. This solution introduces an approach that bridges the gap between event stream discovery and infrastructure management through a sophisticated integration of curation authentication, validation, and automated workflows around events and their streams.

The solution variants leverages a hexagonal architecture pattern that isolates business logic from external concerns, enabling adaptability while maintaining consistent processing rules. A variant of the solution integrates with developer platforms through a plugin interface or operates as a standalone service(for example BackStage, or another services), providing separate interfaces for team-owned events and published event products, creating a clear distinction between internal topic management and shareable data products. The system can run as a standalone service or plug into developer platforms. The hexagonal architecture keeps the business logic separate from the UI layer, enabling deployment as an independent web service, an API-first platform, a plugin for developer portals such as Backstage, GitLab, or Azure DevOps, or a custom plugin for enterprise portals. The core domain layer remains agnostic to the presentation layer—the business logic stays the same regardless of how users access it.

The system's authentication workflow represents a solution variant, utilizing JSON Web Tokens (JWT) and group membership claims from an enterprise identity provider to determine correct access rights through integration with enterprise identity management systems. The system validates bearer tokens from any OIDC-compliant identity provider, including but not limited to Okta, Azure AD, Auth0, or Keycloak. The authentication module extracts group claims from the token and uses those to determine topic visibility and permitted actions. While JWT is an enabled token format, the architecture could accommodate other token formats such as SAML assertions or OAuth 2.0 access tokens, provided they contain group membership claims in a parseable format. This approach ensures that topic visibility and publishing permissions align with organizational security policies while enabling self-service discovery by the system users. The solution also works with other token formats such as SAML assertions or OAuth 2.0 access tokens, as long as they contain the group membership claims in a parseable format.

Most significantly, the solution variants introduce an infrastructure-as-code approach to event access management. When users request access to event products, the system automatically generates validated code snippets and initiates pull requests in the event owners' provisioning repositories. This methodology ensures that cross-access permissions are maintained as infrastructure rather than point-in-time configurations, providing better governance and continuity. The solution uses a GitOps workflow where infrastructure state lives in version control as declarative configuration files. Team Owners use an onboarding interface to provision their team’s access through an automated TerraForm pipeline: the Team Owner enters a team email address, the system retrieves team metadata from a roster event handler service, solution variants can use generates Terraform (or OpenTofu) configurations defining service accounts, RBAC configurations, and ACLs scoped to the team’s topic prefix, and executes reusable infrastructure workflows to apply the configurations. Terraform state serves as the digital oracle for all onboarded teams. The platform team has an admin interface that uses the same onboarding pipeline but allows overriding domain and subdomain assignments, triggering onboarding for any team, updating cross-access lists, and managing identity provider group associations.

The system enforces quality standards through automated validation of business metadata, including creation dates, ownership information, and contact details. This curation ensures that only production-ready, well-documented event products become discoverable, saving developers time by eliminating the need to sort through deprecated or unsuitable topics. The system uses a two-layer permission model: user-level permissions based on group claims from the authentication token determine whether a user is an admin, viewer, or other role type, while team-level permissions stored in the Team Details service control which teams have access to which topics. When a user authenticates, the system maps groups to teams and the user inherits the team’s baseline permissions. If a group grants higher privileges than the team’s baseline, the system elevates the user to the higher level, always applying the most permissive applicable permission. Topics are associated with teams through domain/subdomain prefix patterns, which controls access.

From a scalability perspective, the solution variants implements pagination and efficient filtering mechanisms that enable enterprise-wide deployment without performance degradation and in some cases optimization services. The separation of concerns between team events and published products, combined with environment-specific filtering, creates an useful discovery experience that scales with organizational growth.

The Event Catalog's approach to version control and deprecation management ensures that various teams can evolve their event products while maintaining clear communication about changes and lifecycle status. This systematic approach to event product management and cataloging represents a significant improvement over traditional methods of event stream discovery and access control.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1: Schematic view of a Retail System showing various Product Offerings (Physical Goods, Digital Goods, Services and Hybrids) and their integration with the Event Stream System.

FIG. 2: Illustration of Management Systems, including Information Management System, Inventory Management System, Pricing Engine, and Order Management System with their interconnections.

FIG. 3: Diagram of Content Data Enrichment Services showing the processes of Cleaning, Categorizing, Classifying, Image Processing, and Optimization capabilities.

FIG. 4: Flowchart of the Content Data Process depicting the lifecycle from product creation through enrichment to consumer availability.

FIG. 5: Architectural diagram showing the relationship between Product Management Systems, Data Enrichment, and Data Aggregation System components.

FIG. 6: Detailed structure of the Product Data Structure showing various fields including identification, classification, timing, and status information.

FIG. 7: Schematic representation of Management and Storage Systems subsystems, focusing on Product Service and Middleware System components.

FIG. 8: Diagram showing different Event Types and their corresponding Event Streams in the system.

FIG. 9: Flowchart illustrating the Topic Search process within the event catalog system.

FIG. 10: Flowchart depicting the Schemas search process for managing event data structures.

FIG. 11: Flowchart showing the Publish Events process for distributing event information.

FIG. 12: Flowchart of the Unpublish Events process for removing events from the system.

FIG. 13: Flowchart detailing the Request Access process for system authorization.

FIG. 14: Flowchart of the Business Metadata Binding process for associating metadata with events.

FIG. 15: Flowchart showing the Tag Binding process for event categorization.

FIG. 16: Flowchart illustrating the Remove Tag process for managing event classifications.

### DETAILED DESCRIPTION

The disclosed technology encompasses systems, methodologies, and/or computer program commodities at varying degrees of technical integration. Such a computer program commodity may comprise a machine-readable storage medium (or multiple mediums) bearing machine-executable instructions to prompt a processor to execute components of the specified technology.

This machine-readable medium is a physical entity capable of maintaining and storing instructions to be utilized by an instruction execution apparatus. The medium could be, for example, but not restricted to, electronic, magnetic, optical, electromagnetic, semiconductor storage devices, or a fusion of these. A non-limiting list of specific instances of the machine-readable medium includes portable computer diskettes, hard drives, RAM, ROM, EPROM or Flash memory, SRAM, CD-ROMs, DVDs, memory sticks, floppy disks, and mechanical devices like punch-cards or tangible structures with instructions. It should be clarified that the aforementioned medium does not consider transitory signals in isolation, like free-propagating electromagnetic waves or electrical signals over wires.

The machine-executable instructions detailed can be transferred to diverse computational devices from the machine-readable medium or an external computer or storage via networks like the Internet, LANs, WANs, or wireless networks. Such networks may integrate copper or optical fibers, wireless transmission mechanisms, routers, firewalls, switches, gateway computers, and edge servers. Within each computational device, a network interface or adapter fetches the instructions from the network, forwarding them for retention in the device's machine-readable medium.

Instructions facilitating operations of this technology might be encoded as assembler instructions, ISA instructions, machine codes, microcode, firmware instructions, circuit configuration data, or code (both source and object) in diverse programming languages. Examples include but aren't restricted to object-oriented languages like Python, Java, C++, and procedural ones like the "C" language. These instructions might operate wholly on a local computer, partly on local and remote computers, or entirely remotely. Remote computers can be linked via networks, inclusive of the Internet via ISPs. In certain cases, hardware such as FPGAs or PLAs could employ the instructions, utilizing their state data to modify the hardware to actualize facets of the technology.

The technology's facets are expounded with reference to flowcharts and block diagrams of methods, systems, and computer program products per its solution variants. Each block in these can be realized via machine-executable instructions. These instructions could be presented to a processor in general-purpose computers, specialized computers, or other programmable data apparatuses, crafting a machine that institutes the functions denoted in the diagrams. Furthermore, these instructions could be conserved within a machine-readable medium directing device to operate in a specific fashion. The instructions could also be loaded onto a computer or device to prompt a sequence of tasks producing a computer-driven process.

The depicted flowcharts and diagrams exhibit potential system, method, and product architectures and functionalities per the technology's solution variants. It's essential to note that these blocks, or their combinations, can be realized by hardware systems specifically designed for those tasks or combinations of hardware and machine instructions.

While multiple solution variants have been detailed, skilled individuals will recognize that modifications can be made without diverging from the broader aspects of the technology. The term "user" here pertains to any individual or entity interacting with the described contract analysis and generation system. "User device" signifies any computational apparatus, from PCs to mobile devices like smartphones, laptops, wearables, and more, employed to access the system. The term "entity" encompasses organizations or user groups engaging with the system, such as businesses or companies either operating or accessing the system.The solution variants described provide a highly available, efficient, and comprehensive system for managing content data.

The system and associated methods use an event-driven architecture that allows content data to be gathered from source systems and enriched in real time or near real time to facilitate consistent end user experiences across a variety of digital channels. Event system architecture is a software design pattern built around the concept of events-discrete changes or happenings in a system-and how different parts of an application react to them. The components comprise Event Publishers/Producers-Components that detect and announce when something happens (like a user clicking a button or data being updated) Event Subscribers/Consumers-Components that listen for specific events and act when they occur Event Bus/Message Broker-The central system that manages event routing between publishers and subscribers, often handling things like queueing and delivery guarantees

For content management and reuse in a repository, the following actions take place:

### Content Storage

1. Content is broken down into discrete, reusable components
2. Each piece is stored with metadata describing what it is, when it was created/modified, who owns it, etc.
3. The actual content and metadata are typically stored in specialized databases optimized for the content type (document databases for text, binary storage for media files)

### Cataloging System

1. Implements a taxonomy (classification system) to organize content
2. Uses tags, categories, and relationships to make content discoverable
3. Maintains indexes for quick searching and retrieval
4. Tracks content versions and maintains audit trails

### Content Reuse

1) Content is modularized so pieces can be mixed and matched
2) References between content pieces are maintained (like linking related articles)
3) Changes to source content can automatically propagate to wherever it's being reused
4) Access controls ensure content is only reused according to permissions

The event system ties this together by:
1. Detecting content changes (new uploads, updates, deletions)
2. Notifying relevant systems (updating search indexes, triggering workflows)
3. Managing content lifecycle (archiving old versions, scheduling updates)
4. Coordinating access (managing concurrent edits, maintaining consistency)
5. Specifically, this event-driven architecture uses event streams to coordinate the creation, exchange, modification, and storage of content data. Using this architecture, the entire lifecycle of a given product can be captured, from origination within a business system (such as a information management system) to discontinuation of the product. This architecture further enables a variety of different applications, including improved content discovery, (e.g. real-time inventory tracking, dynamic pricing capabilities, and streamlined product lifecycle management.) The content repository is integrated with a developer platform through an Event Catalog plugin, or is accessible as a standalone service. This interface provides authenticated access through an enterprise identify provider (like Okta) and interfaces with internal services to manage topic permissions and publishing rights.

The event-driven architecture is built on a hierarchical relationship between event streams and topics. An event stream represents a flow of related events through the system. Within each event stream, topics serve as logical groupings of specific event types that share common characteristics or business purposes.

For example, a product catalog event stream may contain multiple topics such as 'product-updates', 'price-changes', and 'inventory-levels'. Each topic maintains its own access controls, metadata, and versioning while inheriting the broader governance rules of its parent event stream. This hierarchical structure enables event routing and management while maintaining granular control over specific event types.

When events are published to the system, they are directed to specific topics within an appropriate event stream. Consumers can then subscribe to individual topics rather than processing the entire event stream, allowing for precise access control and efficient event processing. The Event Catalog maintains metadata about both streams and topics, with topics being the primary unit of discovery and access management.

This relationship is reflected in the system's dual-interface approach, where team-owned events and published event products are managed as distinct topics while flowing through the same underlying event streams. This structure enables teams to maintain independent control over their specific topics while operating within the broader event streaming infrastructure.

The solution variants enable business systems to publish events to an event stream, thereby making the content data immediately available to a variety of different components. Specifically, this configuration allows for the enrichment of both available and upcoming content data throughout their lifecycle, as opposed to enriching content data after the product has been made available for sale. The solution variants further improve data replication and improved data access through event streams. Because the system enables the history of each product to be traced, from the period the product is created through to the time the product is discontinued, the solution variants help to improve overall data quality.

The solution variants may also reduce operational load on the various business systems and services responsible for managing products, including information management systems, inventory management systems, pricing engines, as well as other systems. Specifically, these systems may offload some data storage and/or communication responsibilities to downstream systems by publishing events with content data to events streams rather than solely maintaining local catalogs of record and managing proprietary APIs for data exchange.

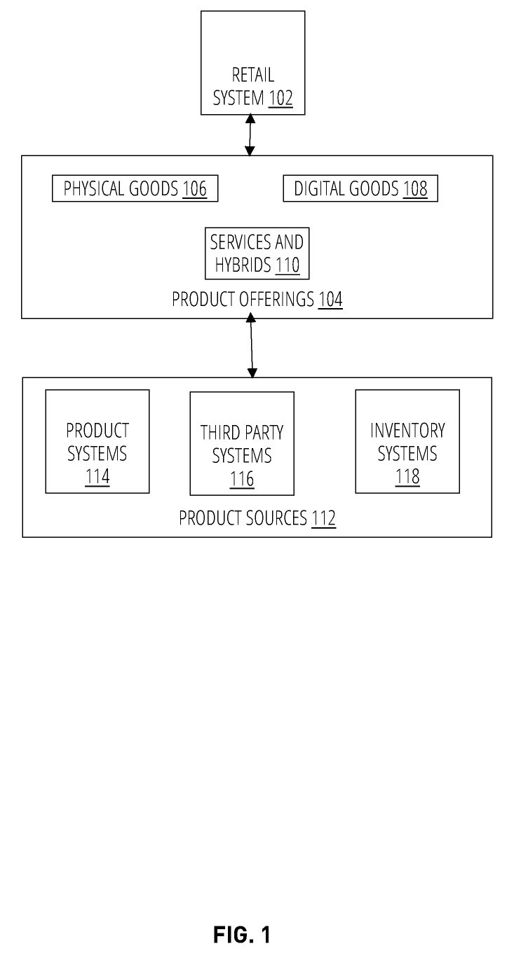

FIG. 1 is a schematic view of a Retail System 102 using real time enriched content data. As shown schematically, inputs to the system include various kinds of Product Offerings 104. For example, Product Offerings 104 may further include Physical Goods 106, Digital Goods 108 and Services and Hybrids 110. A hybrid is a combination of services and other products. These products may originate from various source systems (for example, adding a new product in a Product Systems 114), Third Party Systems 116 like other suppliers’ systems, and/or as part of Inventory Systems 118 (for example, receiving new stock). For clarity, only some exemplary products are shown, however it may be appreciated that any known product types could be used as inputs for the present system shown in FIG. 1. These Product Offerings will then enter Retail System 102 through multiple integrated source channels, each designed to handle specific types of products and their associated data requirements

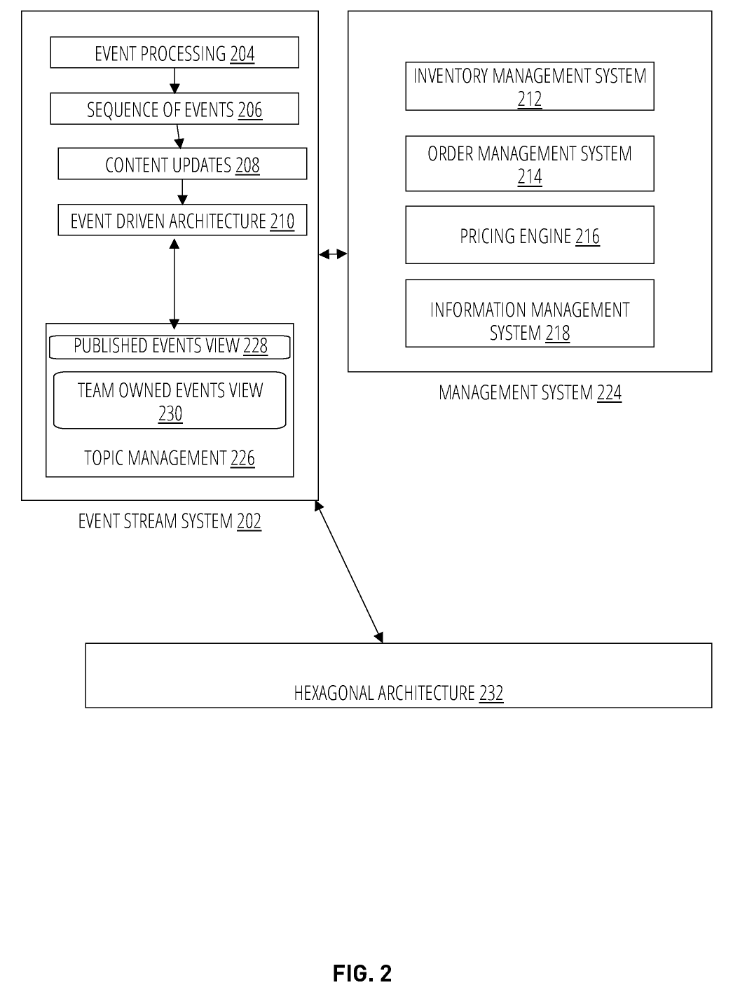

A set of exemplary Management System 224 are shown schematically in FIG. 2. These include an Information Management System 218, an Inventory Management System 212, a Pricing Engine 216, and an Order Management System 214. The system's backend implements a Hexagonal Architecture 232 pattern with three distinct layers: Application, Domain, and Infrastructure. The Domain layer maintains isolation through strongly typed objects and internal validation, enabling the Application layer (which interfaces with a developer platform through a plugin interface or operates as a standalone service) and Infrastructure layer (which interfaces with Kafka clusters and a source control system) to be modified independently. The hexagonal architecture uses adapter patterns in the infrastructure layer, so adapters for other message brokers could be implemented if needed, though the current system is built for and works with Kafka’s topic-based streaming model.

Each of these product management systems provides various kinds of services or functionality. Information Management System 218 enables various functionality for all content data, including attribute management, categorization, digital asset management, product description generation, and search optimization. The Inventory Management System 212 facilitates processing of stock levels and availability. Pricing Engine 216 provides pricing capabilities including base price management, promotional pricing, dynamic pricing, and competitive price monitoring. Order Management System 214 includes applications and infrastructure that supports order processing from various sales channels. It may be appreciated that in other solution variants, still other product management systems could be used. For example, management systems could further include systems to facilitate managing bundles, systems to facilitate managing subscriptions, as well as additional retail platforms (such as point-of-sale systems). Referring to FIG. 1, system 100 also includes an Event Stream System 202. Event Stream System 202 provides an event-driven architecture for system 100. An 'event' is any message that contains information about a change in state of something, such as a product update. An 'event stream' is a record of a sequence of events. The system interfaces with broker vendor APIs to manage topic creation, tagging, and access control. Topics are managed through a dual-interface system, with separate views for team-owned events and published event products Content Data Enrichment Services 310 can facilitate content data Cleaning 318, Categorizing 320, Classifying 322, Image Processing 324, and Optimization 326. The system implements comprehensive validation of business metadata, including creation date, owning team, team roster ID, topic descriptions, and contact information. Topic Management 226 manages both Team Owned Events View 230 and Published Events View 228 This structured approach ensures consistent governance while maintaining flexibility for different team needs and use cases. Topics can be tagged with additional metadata indicating serialization format and data sensitivity level. Version control is maintained for all topics, with deprecated versions automatically removed from the events catalog.

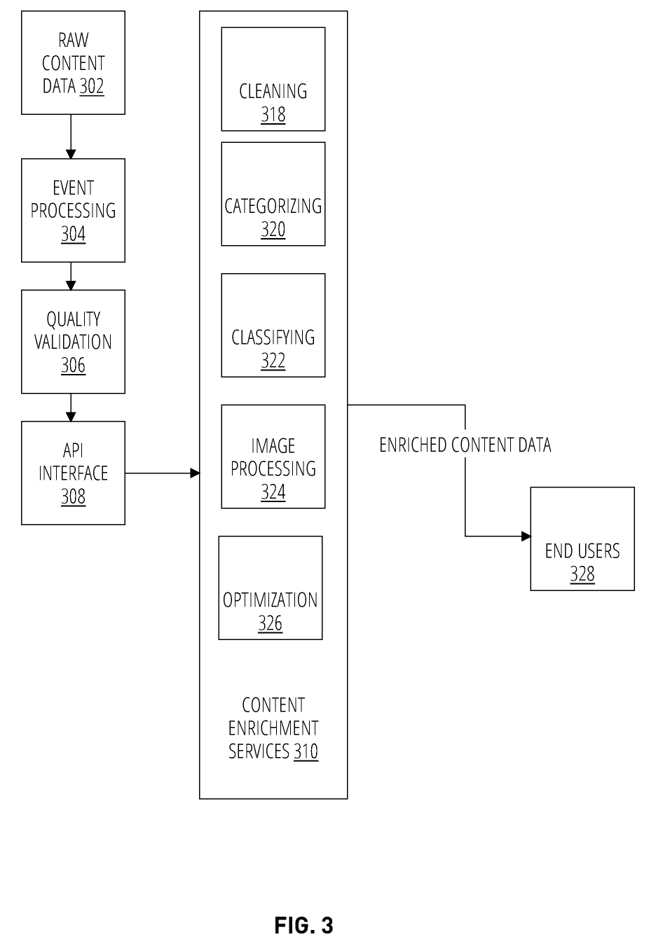

As seen in FIG. 3, Content Data Enrichment Services 310 can facilitate content data Cleaning 318, Categorizing 320, Classifying 322, Image Processing 324, and Optimization 326 (SEO or other optimizations). In some solution variants, data retrieved by components of system 100 can be enriched using Content Data Enrichment Services 310. In some other cases, an application program interface (API) can be used to send raw data and receive enriched data. The system validates topic quality standards through automated checks before enrichment processing. This validation ensures all published event products meet organizational requirements for data quality and completeness. The system also integrates with schema registry for discovery and documentation purposes, querying the schema registry API using business metadata from topics and retrieving schema definitions for event structures based on topic-to-schema mappings. Topics with associated schemas show schema documentation, version history, and field definitions and enable enhanced search and filtering by data structure; topics without schemas have limited discovery features. The system caches schema metadata alongside topic metadata to optimize queries. The system does not validate event payloads against schemas—that remains the responsibility of producers and consumers. The validation process follows a specific sequence to ensure data quality and system integrity. First, the system performs topic quality validation checks before any metadata binding occurs. These initial checks verify fundamental requirements such as topic naming conventions, schema compatibility, and basic structural integrity.

After passing these initial validations, the system proceeds with business metadata binding. This stage associates essential business context with the topic, including creation date, owning team identification, team roster ID, topic descriptions, and contact information. Each metadata field undergoes its own validation during the binding process to ensure completeness and correctness.

Once metadata binding is complete, the system conducts a final validation phase that verifies the entire topic configuration, including the relationships between bound metadata elements and their compliance with organizational standards. Only after successfully completing all three validation phases – initial quality checks, metadata binding validation, and final configuration validation – does the system proceed with enrichment processing.

This sequential validation approach ensures that topics maintain data quality standards while preventing invalid or incomplete configurations from entering the enrichment pipeline. The system maintains audit logs of each validation phase, enabling troubleshooting and verification of the validation process.

By leveraging Event Stream System 202 and Content Data Enrichment Services 310, raw data can be obtained in real or near real time from Product Management Systems 514 and immediately converted into enriched content data, rather than waiting until the product has reached a particular milestone, such as when the product becomes available for sale. The enriched content data can then be consumed by various End Users 328 (for example, ecommerce platforms, mobile apps, and physical retail locations) at any time during the lifecycle of the product. Moreover, using real time enriched content data for all products, regardless of the product's state (for example, upcoming or available) allows for a consistent presentation of data across different sales channels, thereby improving compliance, transparency, accuracy, and customer satisfaction.

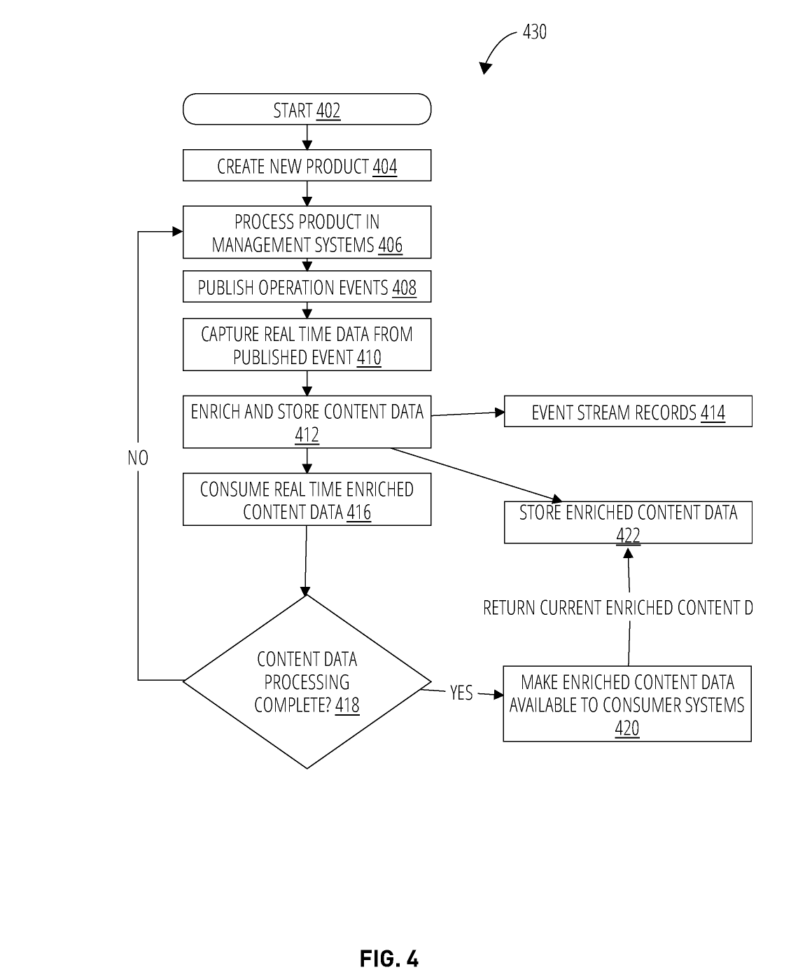

FIG. 4 is a schematic view of a Content Data Process 430 for creating and using real time enriched content data according to a solution variant. In a Create New Product 404 step, a new product is created. The new product may be created in a Product Information Management system, for example, via a content data entry interface. The new product could also be created through inventory receipt or product bundle creation. In some cases, the new product could be a scheduled product, such as an item scheduled for future release.

Next, in Process Product in Management Systems 406 step the product may be processed by one or more product management systems. When publishing a new product through the Event Catalog interface, the system initiates an automated workflow that includes topic validation, broker API integration for event product tagging, and infrastructure-as-code generation for access control. The onboarding workflow uses policy-based conditional approval: after a Team Owner enters team information and initiates the process, the orchestration service generates a Terraform plan, and an automated processor checks the plan against approval policies evaluating proposed infrastructure changes, impact on existing team permissions, naming convention compliance, resource quotas, and security policy compliance. If all checks pass, the workflow applies the changes automatically without platform team review; if checks fail, the system notifies the platform engineering team that manual review is required, including details of the policy violation. Some products may be processed by a single management system, while other products may be processed by two or more management systems, either in sequence or in parallel. In Publish Operation Events 408 step, as each management system performs operations to process a product, information related to those operations may be published as events so that other components in the system can react to these events. In Capture Real Time Data from Published Event 410 step, real time data is captured in response to published events. Specifically, one or more components may consume those published events, which include information about the real time processing of one or more products. Results are paginated to ensure scalability across the enterprise. The system focuses on managing topic metadata and access control rather than handling message content directly, optimizing performance for discovery and access management functions.

In the Enrich and Store Content Data 412 step, the content data associated with the published events can be enriched and stored. Enrichment can be performed by a separate system or service using an API. Access requests for enriched data are managed through an automated workflow that generates infrastructure-as-code through the Code Snippet Service and creates pull requests via the Pull Request Service. The Pull Request Service interfaces with source control APIs; the current implementation integrates with GitHub’s API, though the service is structured to support different SCM systems such as GitLab, Bitbucket, or Azure DevOps as long as they use branch-based workflows. As described in further detail below, enrichment can be performed by a separate system or service using an API. In some cases, the enriched data can be recorded in long term storage, Store Enriched Content Data 422 such as a database or other long-term storage (LTS) system. In other cases, the enriched data can be incorporated into records stored within the event stream itself so that the enriched data is available for lookup in records within the event stream. In some cases, enriched data could be incorporated into the event stream and also maintained in another form of long-term storage, such as a database.

In Consume Real Time Enriched Content Data 416, real time enriched data may be consumed by one or more end users. In some cases, the real time enriched data may be available in records stored in the event stream. In other cases, the real time enriched data may be available in a separate database that stores data outside of the event stream.

In Content Data Processing Complete? 418 step, the system checks to see if the product has been fully processed by the various product management systems. If not, the system returns to Process Product in Management Systems 406 to wait for continued processing. If processing has been completed, the new content data is made available for use in Make Enriched Content Data Available to Consumer Systems 420 step. In some cases, after the content data has been made available it may be maintained in long-term storage as in Store Enriched Content Data 422.

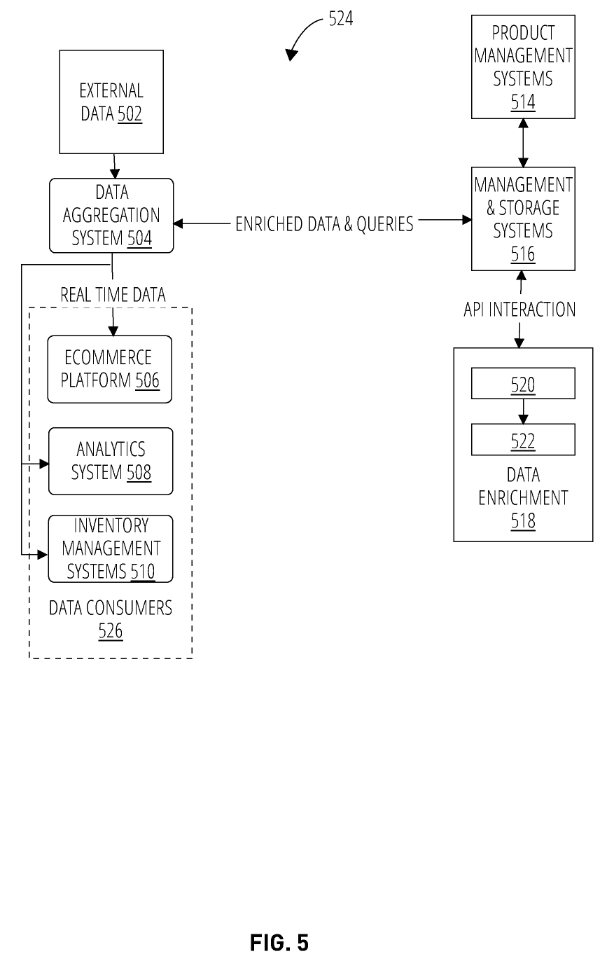

FIG. 5 is a schematic view of one exemplary Architecture 524 for a system that can perform the process described in FIG. 4. New products are created through one or more Product Management Systems 514 At predetermined stages of processing; Product Management Systems 514 generate content events that are published to an event stream. These events are consumed by one or more components within Management & Storage Systems 516. The Management & Storage Systems 516 interacts with Data Enrichment 518 using API 520 and generates enriched content data as described in FIG. 4

External Data 502 may be ingested and routed by a Data Aggregation System 504. A Data Aggregation System 504 may receive the enriched content data. In some cases, the enriched content data may be provided over an event stream. In other cases, Data Aggregation System 504 may make requests to Management & Storage Systems 516, receiving enriched content data in response. Data Aggregation System 504 may also request and gather External Data 502, as well as possibly other externally available information.

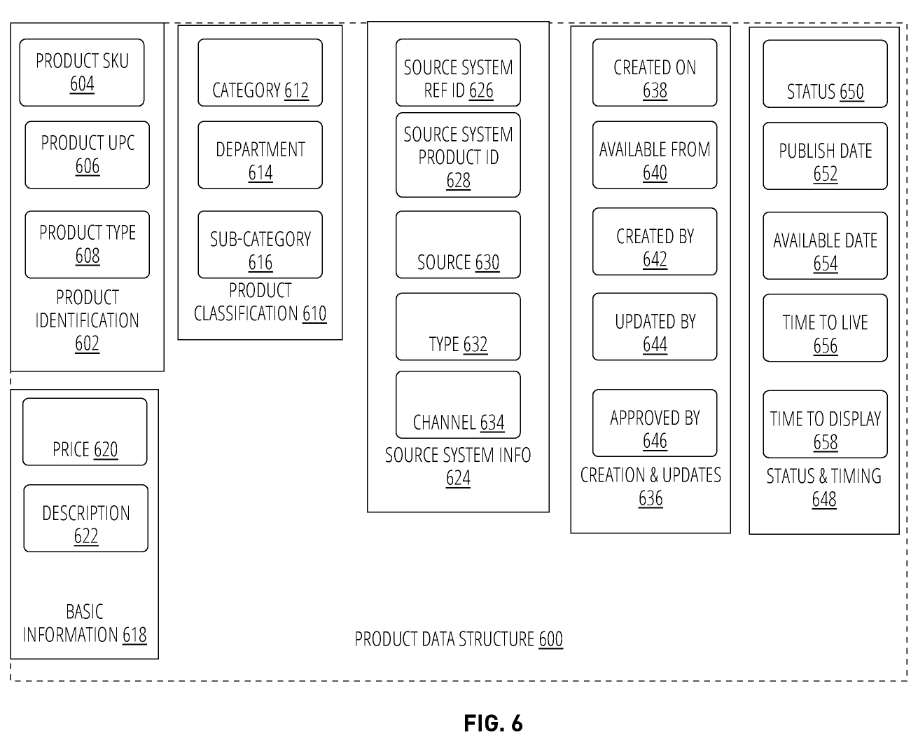

Data Aggregation System 504 generates a set of real time enriched content data for consumption by various Data Consumers 526. In some cases, Data Aggregation System 504 can assemble or append a database for storing product records. This database could then be queried by one or more Data Consumers 526. In other cases, Data Aggregation System 504 may simply query databases from the Management & Storage Systems 516 (for example, database 628 that is discussed below and shown in FIG. 6 and pass the results to one or more Data Consumers 526. Exemplary data consumers include, but are not limited to: an ECommerce Platform 506, Analytics System 508, and one or more Inventory Management Systems 510.

As seen in FIG. 6, Product Data Structure 600 comprises a Product Identification 602, a Product SKU 604, a Product UPC 606, a Product Type 608, a Product Classification 610, a Category 612, a Department 614, a Sub-Category 616, a Basic Information 618, a Price 620, a Description 622, a Source System Info 624, a Source System Ref ID 626, a Source System Product ID 628, a Source 630, a Type 632, a Channel 634, a Creation & Updates 636, a Created On 638, an Available From 640, a Created By 642, an Updated By 644, an Approved By 646, a Status & Timing 648, a Status 650, a Publish Date 652, an Available Date 654, a Time to Live 656, a Time to Display 658, a Product Data Structure 600 among others mentioned below.

The Product Data Structure 600 shows each data field is associated with a predetermined domain of possible values. Product Data Structure 600 includes: a Product SKU 604 that allows systems to record the unique identifier for a given product; a Product UPC 606 that allows systems to record a universal product code for the product; a Product Type 608 that allows systems to record a product type (such as Physical, Digital, Service, Bundle, etc.). Product Data Structure 600 also includes corresponding fields for the product categorization, including a Category 612, a Department 614, and a Sub-Category 616. Product Data Structure 600 also includes: a Price 620 that allows systems to record the base price of the product; a Created On 638 that allows systems to record a date that the product was created; a “Available From 640 that allows systems to record a future day when a product should be made available; a Created By 642 that allows systems to record a creating party for the product (for example, Administrator, Editor, and Contributor); an Updated By 644 that allows systems to record an updating party for the product; and an ”Approved By 646 that allows systems to record an approving party for the product (for example, "Administrator", "Category Manager," etc.).product Product Data Structure 600 includes a Description 622 that allows systems to record detailed product descriptions and specifications.

Product Data Structure 600 includes source system information, such as a Source System Ref ID 626, a Source System Product ID 628, and a Source 630. The ID fields may be populated with numbers, while the Source 630 field may indicate the name of a retail system or vendor participating in the product management. Product Data Structure 600 includes a Type 632 that allows systems to record event types, such as the event types described above. Product Data Structure 600 includes a Channel 634 that allows systems to record the channel or platform through which the product will be sold, such as "web", "mobile," "store," or "marketplace."

Product Data Structure 600 includes a Status 650 that allows systems to record the status of a product, for example either "draft" or "available." Product Data Structure 600 also allows for the recording of dates and times indicating when a product is published, available, time until a product is live, and time until a product is displayed. As shown in Status & Timing 648, Product Data Structure 600 includes a Publish Date 652, an Available Date 654, a Time to Display 658, and a Time to Display 658.

Product Data Structure 600 includes data fields for recording product codes provided by different product management systems (or other systems of record). For example, data structure 800 can include a code for storing numerical codes (201, 310, 311, etc.). Product Data Structure 600 includes data fields for recording information about product overrides, including an "Override Product Name and an Override Category.

Product Data Structure 600 includes data fields indicating information about scheduled products. Specifically, Product Data Structure 600 includes a release field, with values such as "Immediate", "Scheduled", etc. Product Data Structure 600 includes a "Pre-order Duration data field indicating the length of pre-order availability, a "Pre-order End Date" data field indicating a date when pre-orders will cease (or having a value of "Null" if there is no end date), and a Preorder Action field., with values such as "Individual" or "Batch".

Product Data Structure 600 may comprise a record of a particular product. Multiple records may be collected into a single table. The table may be stored within a database, or in a distributed format across multiple systems. In some solution variants, records could be stored in a database or other datastore that is separate from an event stream. In other solution variants, records may be stored as part of an event stream. Records may be stored in a variety of different formats, including using flat files, using indexed sequential access method (ISAM), using heap files, using hash buckets, and/or using B+ trees.

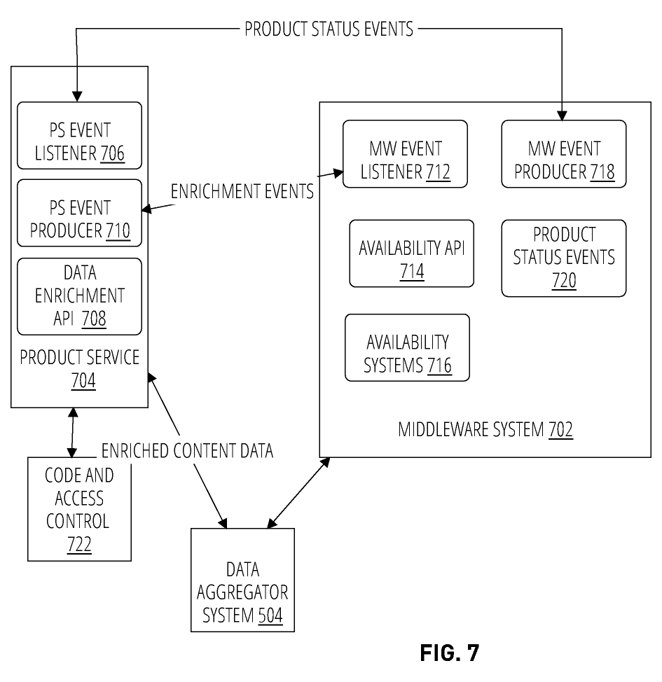

FIG. 7 is a schematic view of subsystems (or subcomponents) of the management and storage systems 506 depicted in FIG. 5. These subcomponents, or services, includes a first subsystem and a second subsystem. In this case, the first subsystem is referred to as Product Service 704 that manages products that have not yet been made available for sale. These includes, but are not limited to: scheduled, upcoming, and draft products. The term upcoming products may also encompass pre-orders. Additionally, Management & Storage Systems 516 can include a Middleware System 702. The Middleware System 702 includes subcomponents or modules to manage availability of products and long-term storage for content data. The Code Snippet Service generates and validates formatted infrastructure-as-code, which is then processed by the Pull Request Service to create branches, commits, and pull requests in the event owner's provisioning repository. This approach ensures access control implementation persists independently of the underlying storage provider. Each team is assigned a unique hierarchical identifier comprising an organizational domain and team subdomain. Topics follow the naming pattern domain.subdomain.topic-name, and the IaC onboarding workflow generates RBACs and ACLs scoped to domain.subdomain.*, meaning teams automatically get access to all topics with their prefix. Teams can grant other teams access to their topics through cross-access lists stored in the Team Details service; when access is requested, the system checks prefix ownership and cross-access list membership before granting permissions.

Product Service 704 comprises various components and processes responsible for listening to an event stream, enriching content data, maintaining a historical log of activity, as well as powering product information for scheduled and draft products. Additionally, Product Service 704 may publish enrichment events for upcoming products. Product Service 704 includes a PS Event Listener 706 for listening to events published on an event stream and an event PS Event Producer 710 for publishing events to an events stream. Product Service 704 also includes a Data Enrichment API 708 for interfacing with one or more data enrichment services (for example, Data Enrichment Services 522 of FIG. 5). Product Service 704 also includes provisions for storing data, such as various database storage. Middleware System 702 includes various components and processes responsible for storing enriched data for upcoming and available products across various retail systems. Middleware System 702 includes an event producer 620 and an event listener 622. Middleware system 604 includes an Availability API 714 that communicates with Availability APIs 714 to reconcile product availability with scheduled products, draft products and upcoming products. Furthermore, Management & Storage Systems 516 includes one or more databases that provide long term storage of all available and upcoming content data. The user interface provides advanced filtering capabilities by environment (cluster), name, domain, and owner. Published topics must meet quality standards and contain required business metadata before becoming visible in the Event Products catalog. This curation ensures developers can efficiently discover production-ready, high-quality data sources without sorting through outdated or unavailable topics.

In operation, new draft and/or scheduled products are published on an event stream by product management systems (for example, Management System 224 of FIG. 2). Events are detected by PS Event Listeners 706 of Product Service 704. New draft or scheduled content data can then be enriched using Data Enrichment API 708. This enriched data may be stored locally in database. Additionally, Product Service 704 can alert Middleware System 702 about newly enriched data. Specifically, PS Event Producer 710 publishes enrichment events, which are detected by MW Event Listener 712 of Middleware System 702. This enriched data may be stored in one or more of databases. Using Availability API 714, reconciliation of scheduled, draft, and upcoming products or their content data are performed. Information about products that have been made available or discontinued can be sent back to Product Service 704. Specifically, MW Event Producer 718 publishes product status events that are received by PS Event Listener 706. In some cases, these can include product available events and product discontinued events. The system integrates with Team Details service to determine topic access permissions and publishing rights. When publishing events, the system interfaces with broker vendor APIs to apply appropriate tagging and access controls. If a topic has the "Event Product" tag, it is considered publicly consumable, appearing in the Published Event Products catalog and on all users’ dashboards so that they can request cross-access for their service accounts. Topics may also carry lifecycle tags: a Deprecated tag indicates a topic is being phased out, causing display of warnings and automatic filtering from published catalogs while maintaining visibility in team-owned views and preventing new cross-access requests; an Archived tag indicates a topic is no longer actively maintained and removes it from discovery interfaces while retaining metadata for historical reference. A topic with a Deprecated or Archived tag cannot receive Event Product designation. Product Service 704 interfaces with the Event Catalog interface to provide authenticated access to topic management functionality. This includes separate interfaces for team-owned events and published event products, with environment-specific filtering capabilities. Access revocation operates at three levels: API-driven revocation through the Team Details service where removing a team immediately revokes all associated user access; time-based bearer token expiration requiring periodic re-authentication with new tokens reflecting current group memberships; and event-driven revocation through consumption of HR system events indicating organizational changes such as employee moves, departures, or role changes, which trigger updates to group memberships so that new tokens no longer contain claims for groups the user left. The system uses a positive security model where access requires active authorization and revocation occurs by removing the authorization source rather than maintaining blacklists.

Enriched content data may be fed to a data aggregator (for example, Data Aggregation System 504 of FIG. 5) from both Product Service 704 and Middleware System 702. Specifically, enriched draft and scheduled content may be obtained from Product Service 704. Additionally, enriched upcoming and available content data can be obtained from Middleware System 702. This data, which collectively may be referred to as enriched content data is used by a data aggregator to provide real time enriched content data for consumption by end users.

Because different components may be primarily interested in particular types of products (for example, draft or scheduled products), some solution variants can use multiple different event streams for different product types.

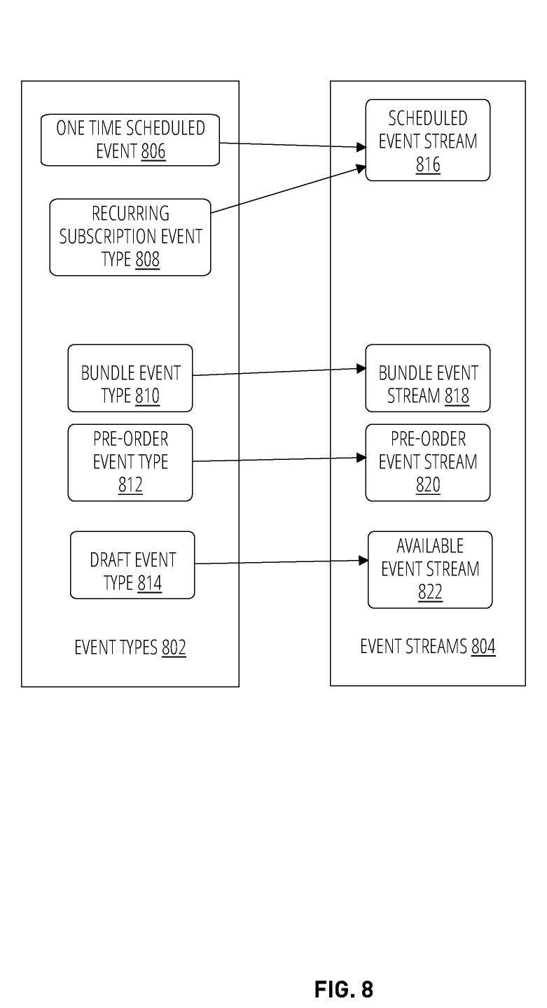

As shown schematically in FIG. 8 , in one exemplary solution variant different Event Types 802 may be published onto one or more different Event Streams 8044.

In this example, Event Types 802 include a Draft Event Type 814 a Pre-order Event Type 812 (for processing pre-order information for a product), a One-Time Scheduled Event 806, a Recurring Subscription Event Type 808 and a Bundle Event Type 810.

Furthermore, Event Streams 804 include a Scheduled Event Stream 816 (which can include both one-time scheduled events and recurring subscription events), a Bundle Event Stream 818, a Pre-Order Event Stream 820, and an Available Event Stream 822 (for indicating when a product has been made available).

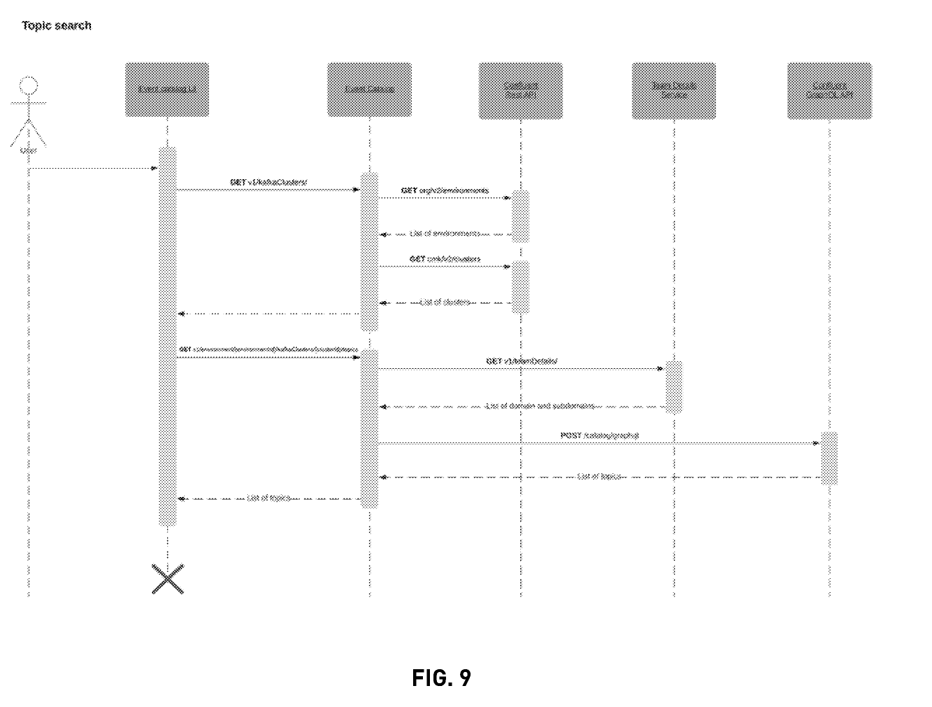

FIGS. 9-16 show variants of Event Types 802 and Event Streams 804 and various Event Processing 204 They also collectively illustrate the event management processes within the event catalog system. These figures detail the base workflows for discovering, publishing, and managing event topics while maintaining data quality and security standards.

FIG. 9 is the Topic Search Process: A detailed flowchart illustrating the system's methodology for searching and discovering event topics within the event catalog. This process enables users to efficiently locate relevant event streams and topics using advanced filtering capabilities across different environments, domains, and ownership parameters. The process incorporates validation checks to ensure only high-quality, production-ready topics are surfaced in search results.

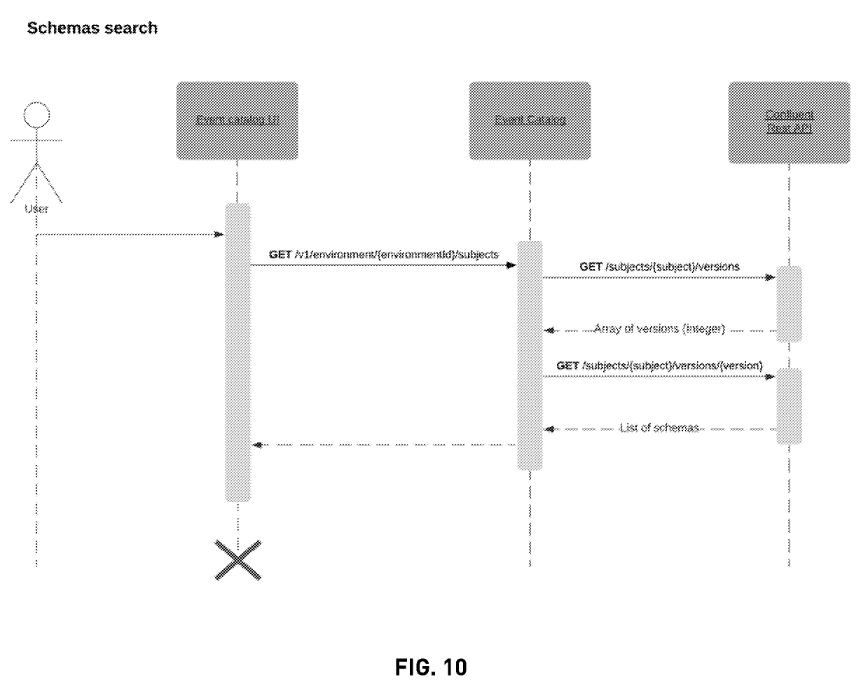

FIG. 10 is the Schemas Search Process: A comprehensive flowchart depicting the system's approach to searching and managing event data schemas. This process demonstrates how the system handles schema versioning, validation, and discovery across different event types. The schema search functionality ensures developers can locate and understand the structure of event data, facilitating proper event consumption and production.

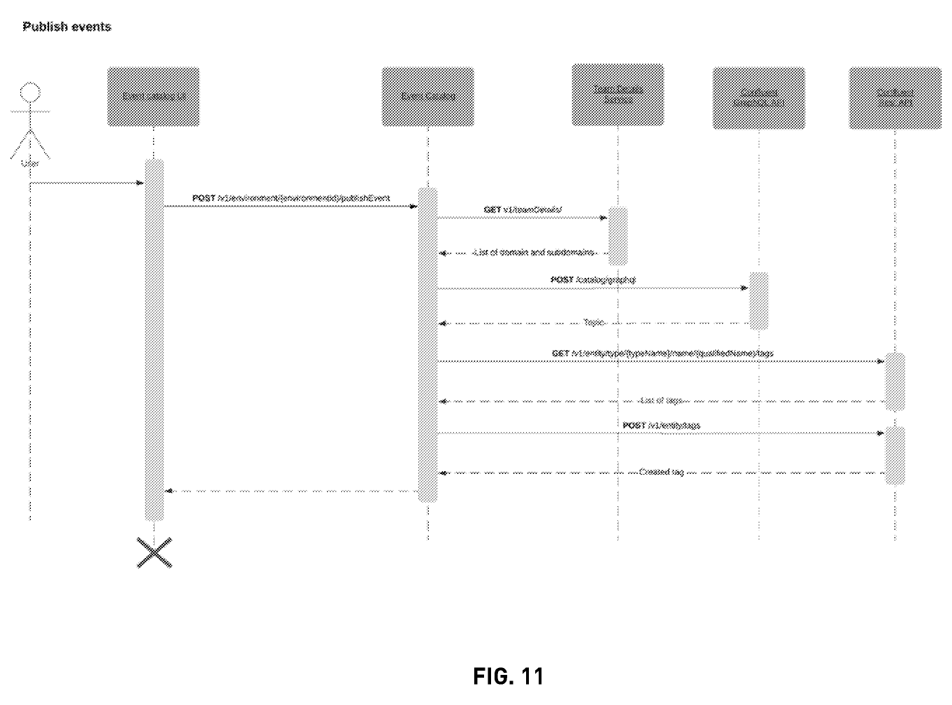

FIG. 11 is the Publish Events Process: A detailed workflow diagram showing the complete lifecycle of publishing events to the event catalog. This process encompasses topic validation, metadata verification, access control configuration, and infrastructure-as-code generation. The workflow ensures all published events meet organizational standards for data quality and security requirements.

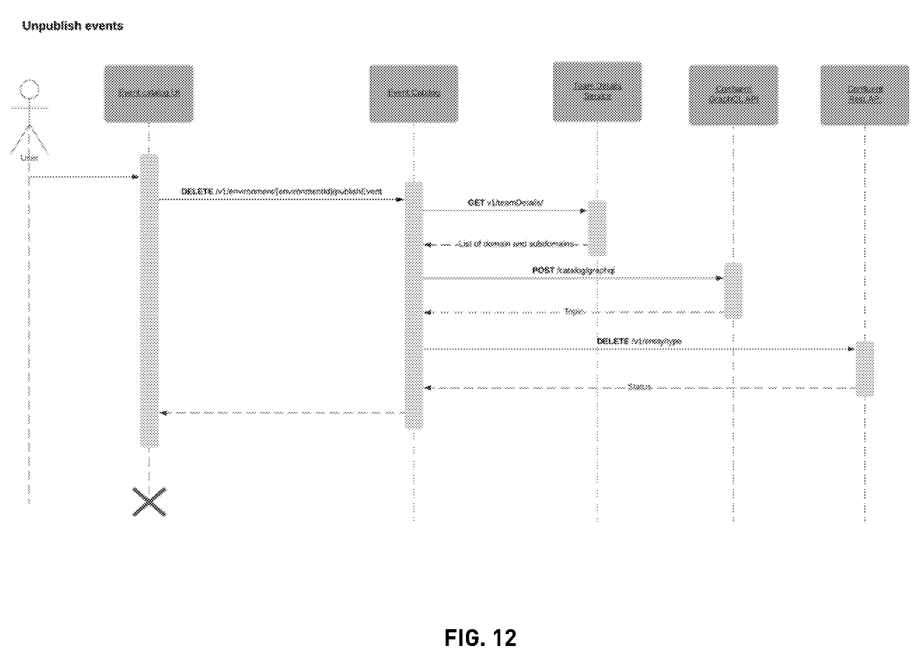

FIG. 12 is the Unpublish Events Process: A systematic flowchart illustrating the steps involved in removing events from the catalog system. This process includes validation of removal requests, handling of dependent systems, and proper cleanup of associated metadata and access controls. The workflow ensures graceful deprecation of event topics while maintaining system integrity.

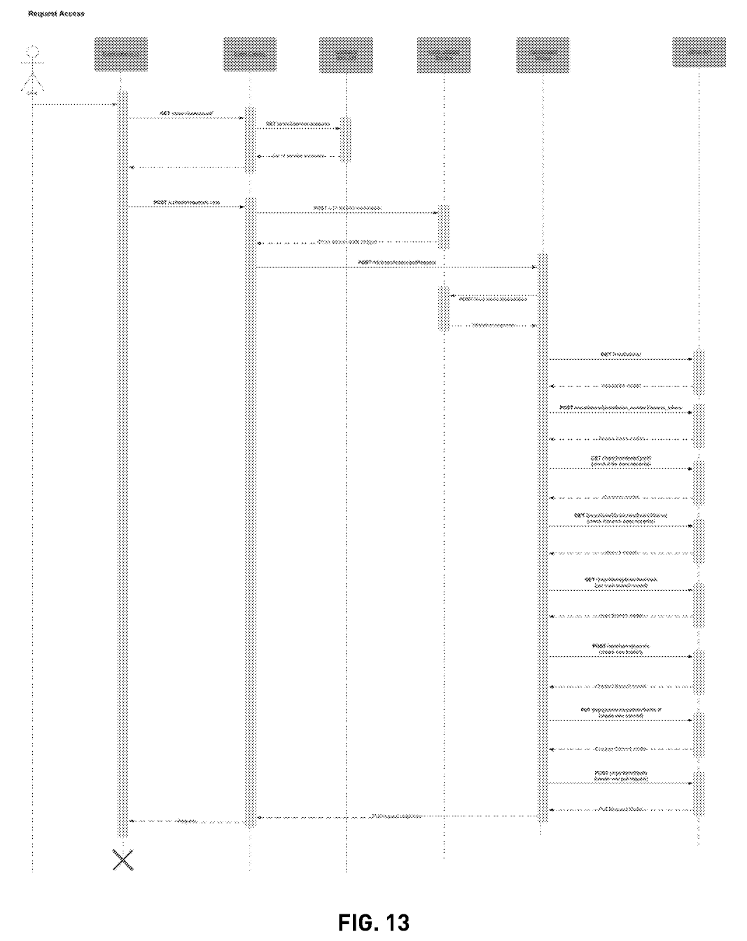

FIG. 13 Request Access Process: A detailed process flow showing how the system manages access requests for event topics. This includes integration with authentication systems, automated workflow for infrastructure-as-code generation, and creation of pull requests through the Pull Request Service. The process ensures secure and auditable access management for event streams.

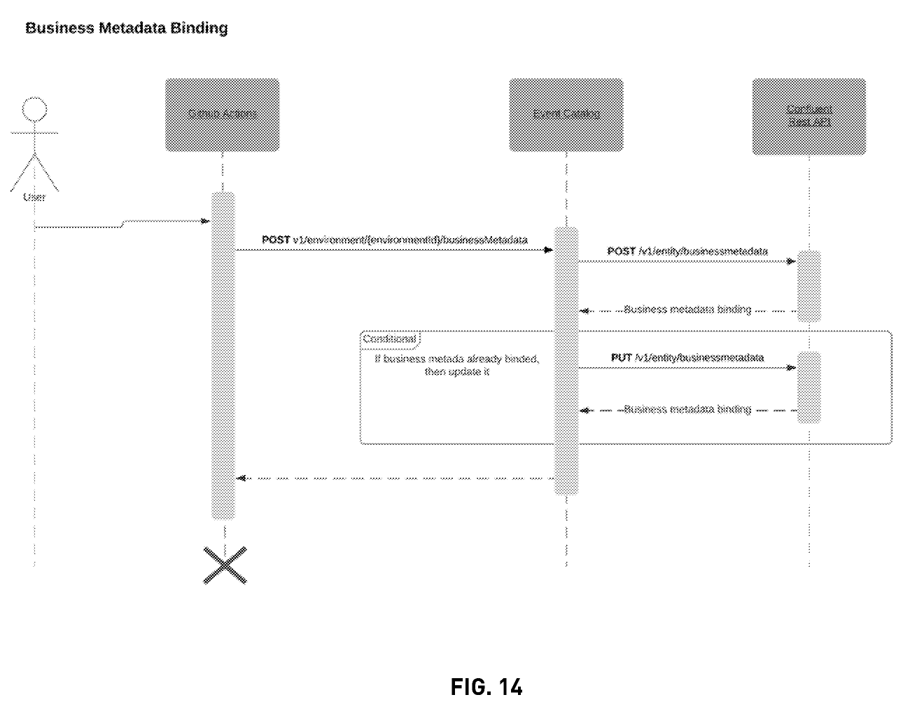

FIG. 14 is the Business Metadata Binding Process: A comprehensive flowchart depicting how business metadata is associated with event topics. This process includes validation of required metadata fields such as creation date, owning team, topic descriptions, and contact information. The workflow ensures all events maintain consistent and complete business context.

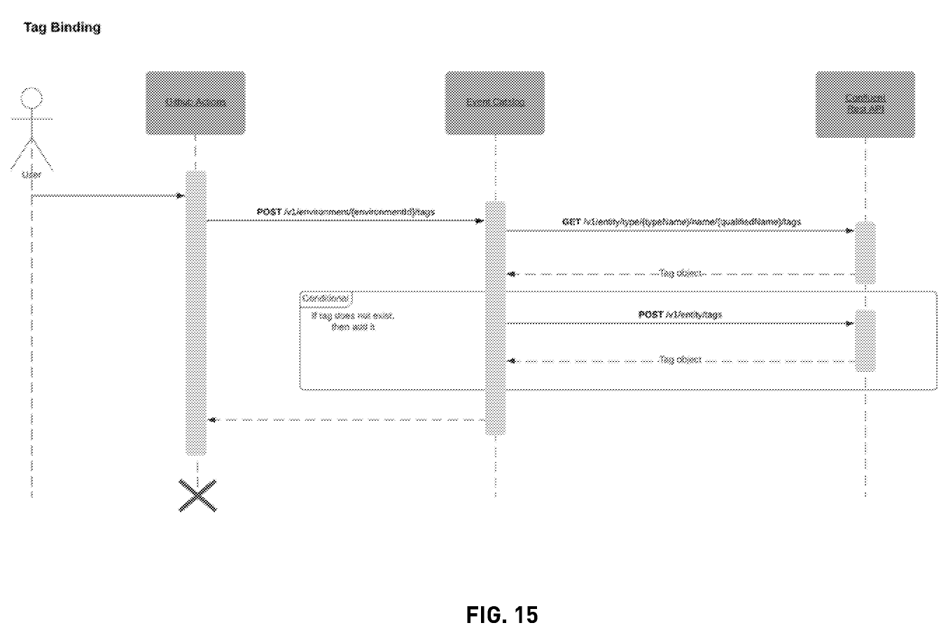

FIG. 15 is the Tag Binding Process: A detailed workflow showing how tags are applied to event topics, including validation of tag formats, association with sensitivity levels and serialization formats, and integration with broker vendor APIs. This process ensures proper categorization and discoverable of event topics within the catalog.

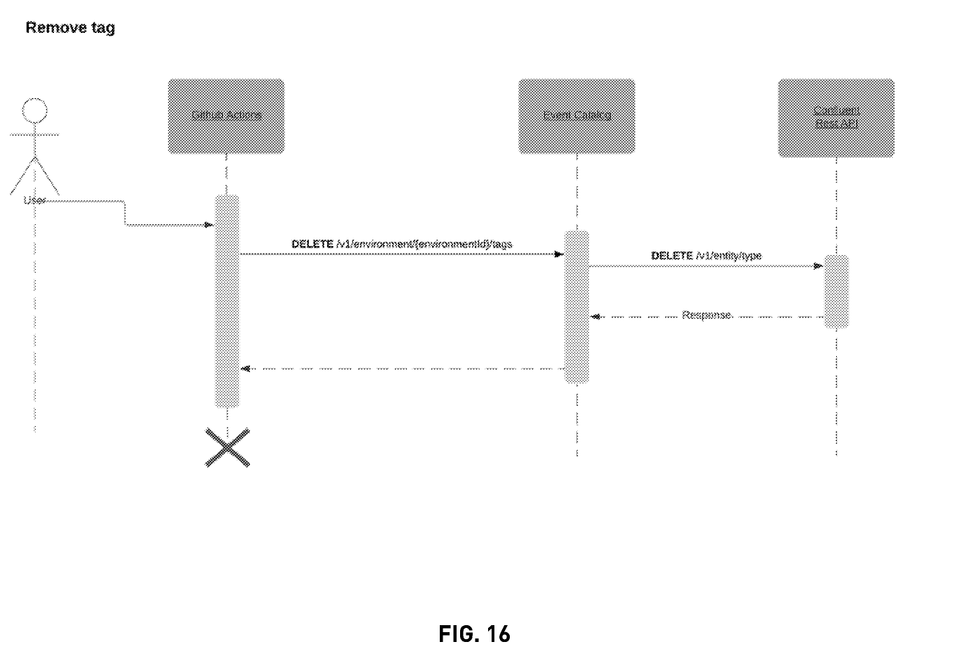

FIG. 16 is the Remove Tag Process: A systematic flowchart illustrating the procedure for removing tags from event topics. This includes validation of tag removal requests, updates to associated metadata, and maintenance of tag hierarchies. The process ensures proper management of event categorization while maintaining system consistency

### ADDITIONAL CONSIDERATIONS

While the preceding description outlines various solution variants in detail, it's important to recognize that the legal scope of the invention is ultimately defined by the claims listed at the end of this patent. The detailed description serves as an illustrative example, and it is not exhaustive of all potential solution variants. Due to the impracticality of describing every conceivable solution variant, alternate configurations may exist—whether using current technologies or those developed after this patent’s filing—that still fall within the scope of the claims.

Throughout this specification, references to singular instances includes plural instances, and vice versa. Likewise, while operations of methods are described separately, they can be performed concurrently or in a different sequence than presented. Components or functionalities described as separate in example configurations may be combined, while those presented as a single entity may be divided into multiple components. These and other modifications or improvements remain within the bounds of the described invention.

In certain solution variants, logic, routines, subroutines, applications, or instructions may be executed via software (e.g., code on a non-transitory, machine-readable medium) or hardware (e.g., special-purpose processors). In a hardware context, these routines can be physical, tangible units configured in specific ways, such as through a field-programmable gate array (FPGA) or an application-specific integrated circuit (ASIC). Alternatively, they may leverage general-purpose processors configured temporarily via software to execute specific operations. Decisions on whether to implement routines in dedicated hardware, software, or hybrid solutions may depend on cost, complexity, or other constraints.

For purposes of clarity, "hardware module" should be understood to mean a tangible entity that can either be physically constructed or configured (permanently or temporarily) to operate in a specific manner. If temporarily configured via software, a general-purpose processor may act as various hardware modules at different times. This flexibility enables the same processor to perform multiple functions dynamically, depending on the system’s current needs.

Inter-module communication between hardware modules may occur through signal transmission over circuits or buses. When modules are instantiated at separate times, data can be stored and retrieved from shared memory structures, enabling asynchronous operation. For instance, a hardware module may execute an operation and store its results in memory, allowing another module to access and process the stored information later.

The operations of methods described in various solution variants may be partially or fully implemented by one or more processors. These processors may be physically located within a single machine or distributed across multiple systems, enabling distributed processing. In some cases, these systems may be in a centralized location, like a data center, while in other cases, they could be spread across multiple geographic locations. When processors are distributed, they may communicate and coordinate their tasks via networked infrastructure, forming a cohesive processing system.

Terminology used herein, such as "processing," "computing," or "calculating," refers to the manipulation of data in physical forms, such as electrical, magnetic, or optical quantities. When the specification refers to "one solution variant" or "a solution variant," it indicates that the described feature may be applicable to at least one possible solution variant. This should not imply that all instances of the phrase refer to the same solution variant.

Additionally, terms like "comprises," "including," and their variants are intended to imply non-exclusive inclusion. For instance, a method that "comprises" certain elements is not limited to those elements alone and includes other components not explicitly listed. Similarly, "or" should be interpreted as inclusive unless otherwise specified, meaning A or B could be true individually or simultaneously.

The descriptions provided are intended as illustrative, non-exhaustive examples. They do not define every possible solution variant, as doing so would be impractical, if not impossible. Moreover, technological advancements and alternate configurations may arise that still fall within the invention’s defined scope.

What is claimed is:

1. A computer-enabled method of managing a content catalog in event-based computer architecture, comprising:
Listening, with a computer, to a content event published to an event stream;
Detecting, via the computer, the content event for catalog items, the content event being published by an information management system and stored in a log for subsequent use by a second event consumer, and the content event being associated with a set of retail data, wherein the content event is received from the information management system and from an event producer;
Sending, by the computer, a request to enrich a set of content data, the set of content data originally including raw data, the enriching occurring in real time after detection of the set of content data and being performed by a data enrichment application programming interface (API);
Receiving, by the computer, a set of enriched content data and publishing an enriched data event by the event producer for use by the second event consumer, the set of enriched content data including the enriched draft content data and the enriched scheduled content data, the enriched content data being converted from a raw format into an enriched format , wherein the information management system includes a datastore configured to temporarily store the content data and a long term storage configured to persistently store the content data, and wherein the set of enriched available content data is stored in the long term storage and wherein the enriched draft content data is stored in the datastore;
aggregating, by a data aggregator, the enriched draft content data and the scheduled content data from the information management system and making the enriched draft content available and the processed content data for consistent catalog presentation;
analyzing, via the computer, the set of enriched content data; and
maintaining, via the computer, catalog consistency across a set of sales channels using at least a catalog management algorithm that provides for improved product discovery based on the enriching and aggregating the set of content data.

2. The computer-enabled method of claim 1 further comprising: validating, by a computer, a topic quality standard; the topic quality standard further comprising generating a topic validation request to verify a topic meets predefined quality requirements; checking for required business metadata further comprising a creation date, an owning team, a team roster ID, a topic description and at least a contact information; verifying a set of version control information is present; and confirming the topic does not contain a deprecated tag before allowing publication as an event data product.

3. The computer-enabled method of claim 1 further comprising: managing by computer, an access control through an infrastructure-as-code generation further comprises: receiving an access request specifying at least a service account and a set of access type requirements; invoking a Code Snippet Service to generate a formatted infrastructure code; creating a branch in an event owner's provisioning repository through a Pull Request Service; submitting the generated formatted infrastructure code as a pull request for an event owner approval; and implementing an approved access through deployment of the infrastructure code.

4. The computer-enabled method of claim 1 wherein the event based computer architecture further comprises: an application layer that interfaces with a Backstage platform plugin; a domain layer that performs validation using at least a strongly typed object; and an infrastructure layer that interfaces with an at least one Kafka cluster and a source control system; wherein the domain layer remains isolated from changes to the application and the infrastructure layers.

5. The computer-enabled method of claim 1 further comprising: aggregating the event data products which comprises: organizing a topic by an environment, a domain, and ownership; implementing pagination for a scalable result presentation; filtering a deprecated version from a published event products catalog; and maintaining separate view for a team-owned event and a published event product available for subscription.

6. The computer-enabled method of claim 1 further comprising an authentication; the authentication by computer further comprising: receiving a JSON web token containing Active Directory group memberships; validating the token through an Okta authentication service; mapping a security group to access rights through a Team Details service; and determining the topic visibility and a publishing permission based on the validated group memberships.

7. The computer-enabled method of claim 1 further comprising: monitoring a topic version and a deprecation status; automatically removing the deprecated topics from the Event Products catalog; tracking a cross-access implementation through at least a infrastructure-as-code repositories; and maintaining at least an audit trail of an access request and an approval through the pull request history.

8. An apparatus for managing an event data product catalog in an event-driven computer architecture, comprising:
a Backstage platform plugin configured to provide a user interface with at least a separate view for a team-owned events and a published event product;
an authentication module configured to: validate at least an JSON web tokens containing an Active Directory group membership through an Okta interface with a Team Details service to map at least a security group to access permissions, and determine a topic visibility and a publishing right based on a validated group membership;
a hexagonally architected backend comprising: an application layer configured to process requests from a user interface module, a domain layer configured to validate a strongly typed objects and maintain business logic isolation, and an infrastructure layer configured to interface with at least a Kafka clusters and source control systems;
a topic validation module configured to: verify required business metadata including a creation date, an owning team, a roster ID, and a contact information, check a topic version control status and at least a deprecation tags, and ensure the topics meet quality standards before publication as an event data product;
an access control manager configured to: process access requests specifying a service accounts and a required permission, invoke a Code Snippet Service to generate infrastructure-as-code, create a repository branch through a Pull Request Service, and submit generated code as pull requests to an event owners' provisioning repositories;
a discovery interface configured to: provide filtered views of event products by environment, domain, and ownership, implement pagination for scalable result presentation, exclude deprecated versions from a published catalog, and maintain separate displays for team events and available event products; and
a metadata enrichment module configured to: tag topics with serialization format and data sensitivity indicators, maintain version control information, track cross-access implementations, and ensure consistent presentation of enriched event data products across the catalog.

9. The apparatus of claim 8 wherein the authentication module further comprises: a token validation processor configured to decrypt and validate bearer tokens; a group membership resolver configured to interface with enterprise identity services; a permissions mapping engine configured to translate security groups into specific catalog access rights; and an access control enforcer configured to apply mapped permissions across catalog operations.

10. The apparatus of claim 8 wherein the hexagonally architected backend further comprises: a domain model validator configured to enforce strong typing on all data objects; a business rule engine configured to maintain consistent processing logic; an interface abstraction layer configured to standardize communication between architectural layers; and a service locator configured to manage dependencies while maintaining domain isolation.

11. The apparatus of claim 8 wherein the access control manager further comprises: a request validation processor configured to verify service account credentials; a code generation engine configured to produce infrastructure-as-code templates; a repository management interface configured to handle branch creation and pull request submission; and an approval workflow tracker configured to monitor a status of access requests through deployment.

12. The apparatus of claim 8 wherein the discovery interface further comprises: a search index configured to maintain metadata about published event products; a filtering engine configured to process queries based on environment, domain, and ownership parameters; a pagination processor configured to manage a result set partitioning for scalable presentation; and a view state manager configured to maintain separate contexts for team events and published products.

13. The apparatus of claim 8 wherein the metadata enrichment module further comprises: a version control processor configured to track topic iterations and deprecation status; a tagging engine configured to manage serialization format and sensitivity indicators; an audit trail manager configured to maintain records of metadata modifications; and a consistency validator configured to ensure uniform metadata presentation across the catalog.

14. The apparatus of claim 8 wherein the topic validation module further comprises a metadata completeness checker configured to verify required business information; a quality standards enforcer configured to validate topic configurations; a deprecation monitor configured to track and manage topic lifecycle states; and a publication readiness validator configured to ensure topics meet all requirements before becoming available as event products.

15. A system for managing an event data product catalog in an event-driven computer architecture, comprising:
a catalog management server comprising at least one processor and memory storing instructions that, when executed, further configure the processor to:
implement a developer platform interface providing separate views for team-owned events and published event products;
execute an authentication service that validates bearer tokens containing group membership claims from an enterprise identity provider, interfaces with a Team Details service to map security groups to access permissions, and determines topic visibility and publishing rights based on validated group memberships;
operate a hexagonally architected service comprising an application tier processing requests from the developer platform interface, a domain tier validating strongly typed objects and maintaining business logic isolation, and an infrastructure tier interfacing with Kafka clusters and source control systems;
perform topic validation by verifying required business metadata including creation date, owning team, roster ID, and contact information, checking topic version control status and deprecation tags, and ensuring topics meet quality standards before publication as event data products;
manage access control by processing access requests specifying service accounts and required permissions, invoking a Code Snippet Service to generate infrastructure-as-code, creating repository branches through a Pull Request Service, and submitting generated code as pull requests to event owners' provisioning repositories;
provide a discovery service that generates filtered views of event products by environment, domain, and ownership, implements pagination for scalable result presentation, excludes deprecated versions from a published catalog, and maintains separate displays for team events and available event products;
and execute a metadata enrichment service that tags topics with serialization format and data sensitivity indicators, maintains version control information, tracks cross-access implementations, and ensures consistent presentation of enriched event data products across the catalog.

16. The system of claim 15 wherein the authentication service further comprises a token validation component that decrypts and validates bearer tokens; a group membership component that interfaces with enterprise identity services; a permissions mapping component that translates security groups into specific catalog access rights; and an access control component that applies mapped permissions across catalog operations.

17. The system of claim 15 wherein the hexagonally architected service further comprises a domain model validation component that enforces strong typing on all data objects; a business rule component that maintains consistent processing logic; an interface abstraction component that standardizes communication between architectural tiers; and a service location component that manages dependencies while maintaining domain isolation.

18. The system of claim 15 wherein the access control management further comprises a request validation component that verifies service account credentials; a code generation component that produces infrastructure-as-code templates; a repository management component that handles branch creation and pull request submission; and a workflow tracking component that monitors a status of access requests through deployment.

19. The system of claim 15 wherein the discovery service further comprises a search indexing component that maintains metadata about published event products; a filtering component that processes queries based on environment, domain, and ownership parameters; a pagination component that manages result set partitioning for scalable presentation; and a view state component that maintains separate contexts for team events and published products.

20. The system of claim 15 wherein the metadata enrichment service further comprises a version control component that tracks topic iterations and deprecation status; a tagging component that manages serialization format and sensitivity indicators; an audit trail component that maintains records of metadata modifications; and a consistency validation component that ensures uniform metadata presentation across the catalog.
